(19) United States
(12) Patent Application Publication
(10) Pub. No.: US 2006/0098861 A1
(43) Pub. Date: May 11, 2006

(54) Image analysis method, apparatus and software

(76) Inventors: Chung Wah See, Leicester (GB); Michael Geoffrey Somekh, Nottingham (GB); Mark Charles Pitter, Nottingham (GB)

Correspondence Address: BAKER & BOTTS, 30 ROCKEFELLER PLAZA, NEW YORK, NY, 10112, US

(21) Appl. No.: 10/521,995

(22) PCT Filed: Jul. 14, 2003
(86) PCT No.: PCT/GB03/03052

§ 371 Date: Sep. 12, 2005

(30) Foreign Application Priority Data
Jul. 18, 2002 (GB) 0216641.1

(51) Int. Cl. G06K 9/00

(52) U.S. Cl. 382/145

(57) ABSTRACT

An image analysis apparatus comprises a microscope (102) arranged to capture an image of a sample (122), a processor unit (114) arranged to process the image and a drive mechanism (108). The drive mechanism (108) is arranged to effect relative motion between the sample (122) and the microscope (102) typically along an optical axis of the microscope (102). The microscope (102) is arranged to capture a plurality of images (402a-404c) of the sample (122) at a plurality of points, typically, along the optical axis. Relative motion of between the sample (122) and the microscope (102) typically, along the optical axis is effected by the drive mechanism (108) and the processor unit (114) is arranged to divide each of the plurality of captured images (402a-404c) into a plurality of sub-images and select one of each of the plurality of sub-images having the best focus characteristics.

This invention relates to an image analysis method, apparatus and software arranged to carry out image analysis. More particularly, but not exclusively it relates to a method, apparatus and software for measuring the deformation of a substrate between an initial state and a second state,

The analysis of the deformation of objects is of importance in fields as diverse as microelectronics and medical imaging.

As an example only we will discuss semiconductor chip design and analysis. In microelectronics the analysis of the deformation of packaged devices, and the packaging of devices is an important tool in determining failure modes in packaged devices. A principal cause of device failure is strain developing between materials having differing thermomechanical properties within the packaging. Stresses that arise from the materials' thermomechanical properties can result in delamination, hotspots and cracking within a device, all of which can lead to device failure.

The above mentioned modes of device failure have become more acute because of requirements for devices to operate in diverse environmental conditions, with many being required to operate at temperatures ranging from sub-zero to in excess of 100° C., and even in a domestic environment temperatures of 0° C. and 50° C. can be experienced by a device. Also, the construction of modern electronic devices, in which structures are formed from multiple layers of differing materials with different thermomechanical properties leads to deformation with changes in temperature. Different regions of the device often have different functions, and as power dissipation increases so does the effect of differential heating of devices, which leads to deformation. Power dissipation per unit volume is a factor in this context.

As deformation due to high strain regions is a major source of device failure it is important to be able to measure strain in electronic devices and their packaging. Reducing strain in devices and their packaging improves device yields during the process of manufacturing the devices and increases the mean lifetime to failure of devices in the field. The analysis of strain in devices and their packaging allows computer models to be developed, and refined, that are used in the design of the chip/device and associated packaging so as to minimise the strains in the actual manufactured devices and packaging.

It is known to use optical techniques to measure thermal deformation of devices (e.g. semiconductor chips), deformation being a measure of the strain present in a device. One known method of measuring thermal deformation is sub-image correlation. This involves obtaining images of the device both before and after deformation. Each of the images is divided into an (m×n) array of sub-images. Corresponding sub-images of the before and after deformation images are compared, for example, using a two dimensional correlation function. The location of a peak within the correlation function provides a quantitative measure of the deformation of the device that has occurred between the two corresponding sub-images. Applying the correlation function across all of the corresponding (m×n) sub-images yields a map of the in-plane deformation, or movement, of the device that has occurred between the acquisition of the two images. It is also known to incorporate, subpixel or non-integral sub-image shifting into more advanced correlation methods. This gives a sub-micron accuracy in measuring in-plane deformations. Such a method is detailed in the paper by M. C. Pitter, C. W. See and M. G. Somekh “subpixel microscopic deformation analysis using correlation and artificial nevral networks,” Opt. Express 8, 322-327 (2001)

Despite the great sensitivity of digital image correlation techniques they still have shortcomings associated with them. For example, image correlation techniques can usually be used to measure in-plane (x-y) deformation only. This is limiting as thermal deformation typically also involves an out-of-plane (z) component that if measured and incorporated into computer models of devices would improve their accuracy.

Also out-of-plane deformation may result in part of a device or sample surface moving out of the focal plane of the imaging system. A poorly focussed sub-image will lead to an error in the measurement of the in-plane deformation due to unclear feature edges, and also due to apparent movement of the surface features being correlated. In these circumstances measured movement, or at least some of it, appears to be an artefact of the different optical paths (a change in magnification can look like a strain).

A problem associated with earlier image correlation techniques is that they require large magnifications to overcome inherent limitations in their analysis code. This requires short working distances that can lead to heating of the optics, and consequent image distortions, when working with hot samples. Also, short focal length lenses tend to have greater lens caused aberration than longer focal length lenses.

Earlier subpixel image correlation techniques suffer from an inherent problem that they employ curve fitting procedures that cannot fit over multiple textures, i.e. regions of significantly differing sample spatial structure or contrast level (the amount of differentiation, between adjacent image features). This is a particular problem for electronic device packages where multiple textures co-exist in a small area, for example dark packaging material adjacent highly reflective silicon.

Another area where deformation and strain measurement is of great importance is the field of medical imaging, for example, of tumours in soft tissue. In imaging these tumours the soft tissue surrounding the tumour is palpitated. The soft tissue exhibits a uniform strain. However, the hard tumour appears as a non-strained region, or a region having a strain that is lower than that of the surrounding soft tissue.

Similarly, the palpitation of muscles surrounding a bone in an ultrasound scan can yield strain images of the bone, for example when a broken bone is pinned or set, in a similar manner to that of tumour imaging. Both of the above-mentioned medical uses suffer from the problems that a lack of out-of-plane measurement limits their quantitative use for the measurement, for example, of the size and/or shape of a tumour.

According to a first aspect of the present invention there is provided an image analysis method comprising the steps of:
i) capturing at least two primary images of at least one part of a sample in a first state using imaging means, the at least two primary images being captured at different focal planes;
ii) capturing at least two secondary images of said at least one part of said sample in a second state using imaging means, the at least two secondary images being captured at differing focal planes.
iii) selecting one of said primary images that has the best definition of at least one feature therein using processing means;
iv) selecting one of said secondary images which has the best definition of said at least one feature therein using processing means, and
v) comparing the primary and secondary images selected in steps (iii) and (iv) in order to determine the displacement, if any, of a feature.

This method has the advantage over current systems that the use of a plurality, stack, of images at a number of focal planes allows a highly correlated pair of sub-images to be determined for each area of the sample. This reduces errors in in-plane displacement measurement, as the definition of features to be compared will be maximised at a highly correlated image, thus routinely allowing sub-micron displacement measurement accuracy. Also, out-of-plane displacements of an area of the sample defined by each of the sub-images can be directly measured by the displacement of the imaging means relative to its initial position. Whilst not noise free, the reduction in errors due to poor focusing achieved using this method allows the effects lost in the noise of prior art arrangements to be recovered using this method.

It will be appreciated that there may be provided more than at least two primary and/or secondary images and each of the primary and/or secondary image may be at a different focal plane to the others. It will be further appreciated that not all of the primary and/or secondary images need be processed in the case where there are more than at least two primary and/or secondary images.

The method may include providing the primary image in the form of initial image captured by the imaging means having a single nominal focal plane depth or in the form of a composite image composed of sub-images each defining a focal plane depth. The use of a composite image reduces alignment problems as each part of the sample is referenced to respective primary images depth. This reduces the need to obtain an optically flat alignment of the sample relative to the imaging means as deformations are ascertained on a sub-image by sub-image basis. This method removes the need for accurate horizontal re-alignment of the sample following deformation as any misalignment can be compensated for by the use of best focus secondary sub-images from different focal planes.

The method may include determining best focus primary sub-images from the at least two primary images and selecting best focus secondary sub-images from the at least two secondary images. It will be appreciated that a best focus sub-image is that where features within the region are at their sharpest focus in comparison to corresponding sub-images at different focal planes. This provides for the formation of the best focus image irrespective of any out-of-plane deformation exhibited by the sample.

The method may include centring the at least two secondary images about a nominal focal plane of a best focus primary image. The method may include effecting relative motion between the sample and the imaging means between image capture operations, typically this will involve substantially equally spaced, stepwise motion.

The method may include measuring in-plane and out-of-plane displacements of at least one feature between a respective corresponding primary image selected in step (iv) and the respective secondary image selected in step (v). The method of may include measuring an out-of-plane displacement of at least one feature by multiplying a number of steps moved by the imaging means in achieving a desired secondary image quality by the step size.

The method may include sub-dividing each of the primary and secondary images into sub-images having an array size of between 16×16 and 64×64 pixels, a typical sub-image comprising 24×24 or 32×32 pixels. The sub-image may be as small as 2×2 pixels. Alternatively, the sub-image may be of any shape, i.e. they need not be square or even rectangular. The method may include overlapping adjacent sub-images during step (v) by up to fifty percent of the length of the sub-image or up to seventy five percent of the area of the sub-image. This overlap in the sub-images processing steps increases the spatial resolution, measurement density, of the technique. An overlap greater than 50% introduces redundancy and unnecessary computational step but still may be used to smooth or average displacement measurements where calculation speed is non-critical.

The method may include providing the imaging means in a form including a microscope, typically having a numerical aperture of between about 0.1 to about 0.5. Thus, the method allows the use of high numerical aperture (NA) imaging systems as the tiny depth of focus at high NA can be compensated. The method may include providing the imaging means in a form including an objective lens typically having between about ×5 and about ×50 magnification. The method may include providing the imaging means in a form including a charge coupled device (CCD).

The method may include providing the imaging means in the form of an ultrasound transducer.

The method may include outputting at least one of the following to an output device: a strain map, a deformation map, a numerical measure of deformation, typically in a distance perpendicular to a nominal horizontal plane of the sample. The method may further include providing the output device in the form of one of the following: a visual display unit (VDU), a printer, and a computer readable medium.

The method may include measuring deformations in the (xy) plane to sub-pixel resolution, typically 0.1 to 0.01 of a pixel.

According to a second aspect of the present invention there is provided an image analysis apparatus comprising imaging means arranged to capture a image of at least part of a sample, processing means arranged to process the image and drive means arranged to effect relative motion between the sample and the imaging means characterised in that the imaging means is arranged to capture at least two images of a part of the sample at at least two focal planes, relative movement between the sample and the imaging means being effected by the drive means the processing means being arranged to determine a correlation of each of said images with a reference and to select one of the at least two images upon the basis of said correlation, and the processing means being further arranged to determine a displacement, if any, of at least one feature within said part of the sample.

This apparatus provides a measure of image focus for each area of the sample, typically by dividing each image into sub-images and comparing them to the reference. Thus, curvature of the sample can be compensated for and measured far more accurately than in prior art arrangements where a single focal plane is assumed across the sample. Additionally, the use of an individual focal plane for each sub-image reduces errors in xy plane deformation measurement as errors associated with poor focussing are reduced.

The processing means may be arranged to select a best focus sub-image, typically having the highest correlation with said respective reference. This produces a composite best focus image thus minimising focussing errors in (xy) deformation measurement.

Each reference may be a image either from an image having a single focal plane, or selected from a plurality of sub-images captured at a plurality of focal planes or from a composite image where a plurality of sub-images define at least two localised focal planes.

The imaging means may be arranged to capture a plurality of images centred about a best focus focal plane of the imaging means when the sample is an undeformed state. The drive means may be arranged to effect relative motion between the imaging means and the sample in steps of substantially equal distance.

The imaging means may include a charge coupled device (CCD) camera, typically with an imaging array of between 640×480 and 1024×1024 pixels. The imaging means may include a microscope, such a microscope typically having an objective of about ×5, about ×50 or greater. The microscope may have a numerical aperture of between about 0.1 to about 0.5, often about 0.25 or above.

The imaging means may be an ultrasound transducer. The drive means may be arranged to sweep the transducer over a sample. The processing means may be arranged to decorrelate images to remove palpitation of soft tissues, for example muscle and/or fat. This allows the extent (e.g. size) of hard tissue, for example a tumour or a bone, to be ascertained more accurately than is currently the case as soft tissue effects can be removed from the image by the processing means.

The processing means may be a personal computer (PC) or other computing device, for example a workstation. The processing means may be arranged to divide each image into sub-images of between 16×16 and 64×64 pixels, typical sub-images sizes are 24×24 or 32×32 pixels. The processing means may be arranged to overlap sub-images boundaries by up to fifty percent of the size of the sub-images.

The processing means may be arranged to generate a strain map, or a deformation map of the sample which is typically output via an output means, for example a printer, visual display unit (VDU) or a file on a computer readable medium.

According to a third aspect of the present invention there is provided a data structure encoded upon a computer readable medium the data structure including:

a first entry corresponding to a data set indicative of a part of a sample in a first state; characterised in that:

a plurality of secondary entries corresponding to at least two inputs received from an imaging means of said part of the sample in a second state;

the first entry and the at least two of second entries are arranged to be operated upon by processing means to derive respective subsets of data; and

corresponding subsets of data derived from the first entry and the at least two of second entries are arranged to be operated upon by the processing means to determine a match therebetween.

The first entry may be an image data file, for example in the form of a GIF, JPEG, TIFF or other suitable image data format. The first entry may be a computer generated model of the sample. The plurality of second entries may be image data files, for example in the form of a GIF, JPEG, TIFF or other suitable image data format.

The subsets of data may be indicative of region of the sample, which may be imaged by the imaging means. The first entry and the plurality of second entries may be arranged to be operated upon by the processing means to determine a best match therebetween.

The second entries may correspond to at least two image data sets obtained at differing focal planes of an imaging means.

The subsets of data files may be arranged to be operated upon by the processing means by the execution of a correlation technique, a fringe projection technique or a spectrum suppression technique thereupon.

According to a fourth aspect of the present invention there is provided a method of assessing the conformance of an electronic device with an accepted standard comprising the method according to the first aspect of the present invention.

The method may comprise providing the accepted standard in the form of a reference, which may be computer generated or physical.

The electronic device may be a discrete component, an integrated circuit or a packaged device.

According to a fifth aspect of the present invention there is provided an electronic device assessment apparatus according to the second aspect of the present invention.

According to a sixth aspect of the present invention there is provided a method of manufacture of an electronic device comprising the method according to the first aspect of the present invention.

According to a seventh aspect of the present invention there is provided an electronic device, the manufacture of which included the use of the method according to the first aspect of the present invention or the apparatus according to the second aspect of the present invention.

According to an eighth aspect of the present invention there is provided a computer readable medium having stored thereupon instructions for causing an apparatus to execute the method according to the first aspect of the present invention.

According to a ninth aspect of the present invention there is provided a program storage device readable by an apparatus and encoding a program of instructions which when operated upon the apparatus cause the apparatus to operate as the apparatus according to the second aspect of the present invention.

According to a tenth aspect of the present invention there is provided computer software which run on an apparatus causes a processing means of the apparatus to generate a data set indicative of an initial image of a sample in said first state and further causes the processing means to produce a plurality of-data sub-sets indicative of regions of the sample from said data set, the software being characterised by:

causing imaging means to capture a plurality of secondary images of the sample in said second state at least two focal planes and causing the processing means to produce a plurality of sub-images corresponding substantially in location to the regions of the sample defined by the sdata sub-sets from each of the plurality of secondary images and subsequently causing the processing means to correlate at least one of the data sub-sets with each corresponding one of the plurality of secondary sub-images using processing means, selecting one of the secondary sub-images for each data sub-set based upon said correlation and determining a displacement, if any, of at least one feature within the sub-image.

According to a eleventh aspect of the present invention there is provided a method of improving the accuracy of in-plane measurement of movement of a feature by compensating for out-of-plane movement of the feature.

The method may include removing decorrelation in the xy plane due to said out of plane movement.

According to a twelfth aspect of the present invention there is provided a computer arranged to have running upon it software according to the tenth aspect of the present invention and/or have the data structure according to the third aspect of the present invention and/or execute the method according to the first aspect of the present invention.

According to a thirteenth aspect of the present invention there is provided a method of diagnosis of a patient's condition comprising the steps of:
i) palpitating a region of soft tissue having a region of hard tissue therein;
ii) capturing a plurality of ultrasound images spaced along said region of soft tissue;
iii) processing the images so as to produce sub-images therefrom;
iv) deriving a strain map of the region of hard tissue;
v) repeating steps (i) to (iv) at a different time;
vi) comparing the strain maps derived in steps (iv) and (v); and
vii) determining if the region of hard tissue has varied in size in the time interval between steps (iv) and (v) from the comparison of step (vi).

The method may include changing, varying or altering the dose of a medicament prescribed to the patient in response to the result of step (vii). Alternatively, the method may include changing a medicament prescribed to the patient in response to the result of step (vii).

The method may include producing a three dimensional profile of the region of hard tissue from the strain maps derived in steps (iv) and (v). The method may include imaging the change in size of the region of hard tissue using the method of the first aspect of the present invention.

The hard tissue may be any at least one of the following: bone, a tumour (e.g. cancerous cells), a bio-compatible matrix having cells growing thereupon.

According to a fourteenth aspect of the present invention there is provided a method of treatment of a patient's condition comprising the steps of:
i) palpitating a region of soft tissue having a region of hard tissue therein;
ii) capturing a plurality of ultrasound images spaced along said region of soft tissue;
iii) processing the images so as to produce sub-images therefrom;
iv) deriving a strain map of the region of hard tissue;
v) repeating steps (i) to (iv) at a different time;
vi) comparing the strain maps derived in steps (iv) and (v);
vii) determining if the region of hard tissue has varied in size in the time interval between steps (iv) and (v) from the comparison of step (vi); and at least one of;
viii) altering the dose of a medicament prescribed to the patient in response to the result of step (vii);
ix) changing a medicament prescribed to the patient in response to the result of step (vii).

The hard tissue may be any at least one of the following: bone, a tumour (e.g. cancerous cells), a bio-compatible matrix having cells growing thereupon.

The invention will now be described by way of example only, with reference to the accompanying drawings, in which:

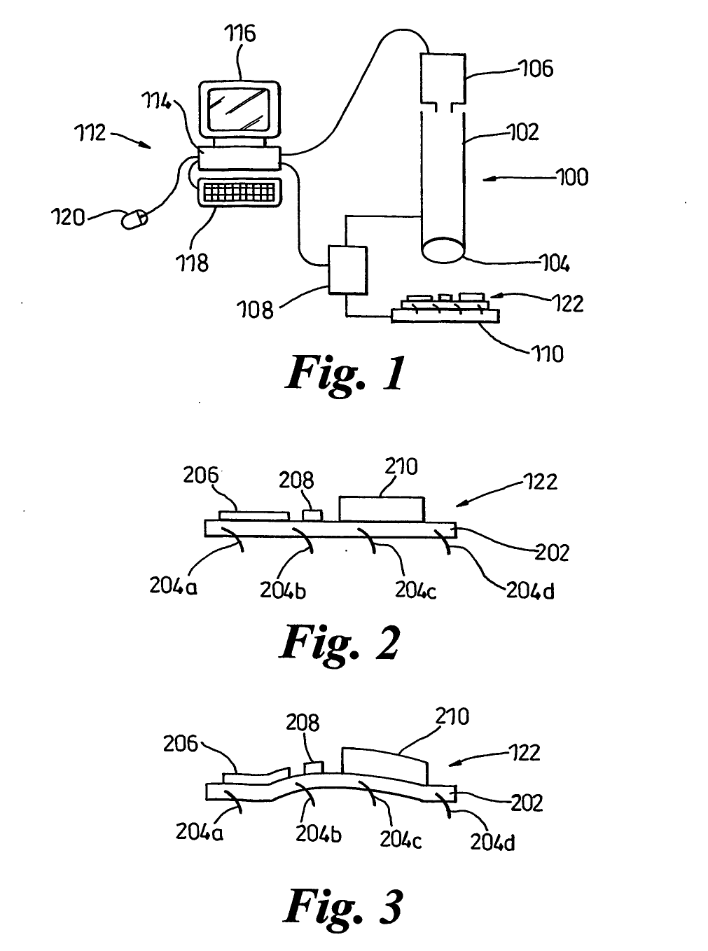

FIG. 1 is a microscope imaging arrangement according to an aspect of the present invention;

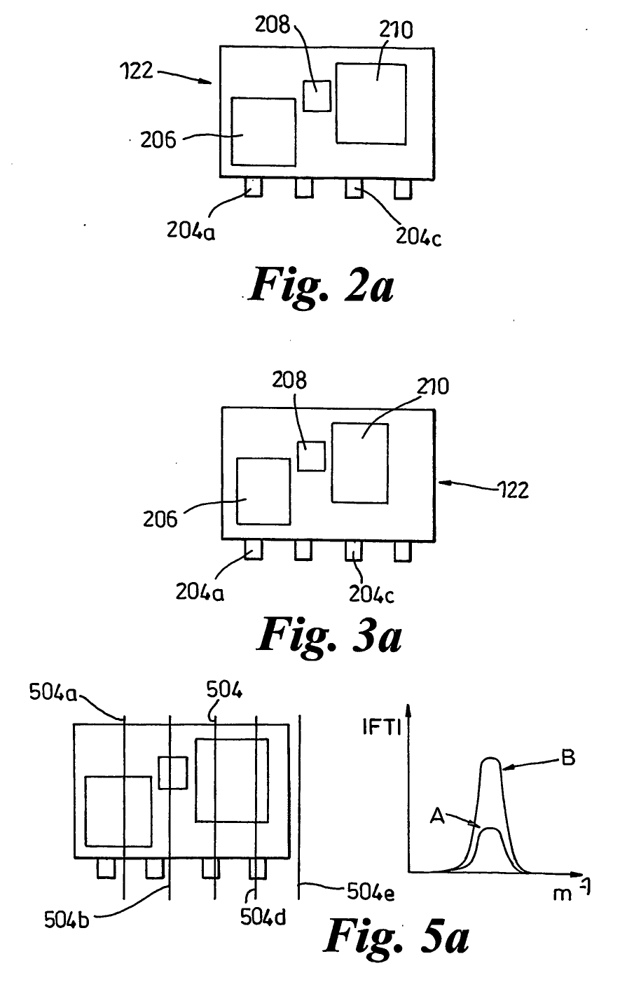

FIG. 2 is a schematic representation of an electronic package prior to deformation;

FIG. 2a is a plan view of the package of FIG. 2 prior to deformation;

FIG. 3 is a schematic representation of the package of FIG. 2 following deformation;

FIG. 3a is a plan view of the package of FIG. 3;

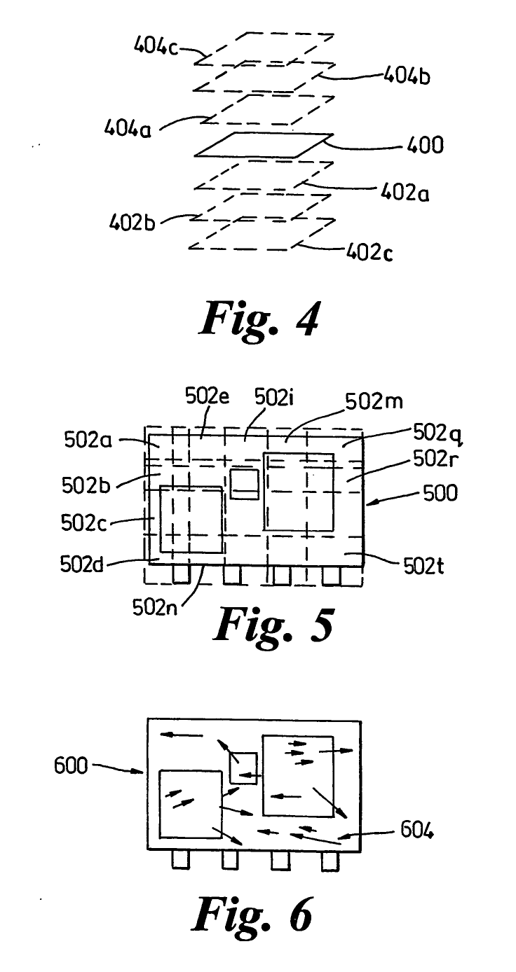

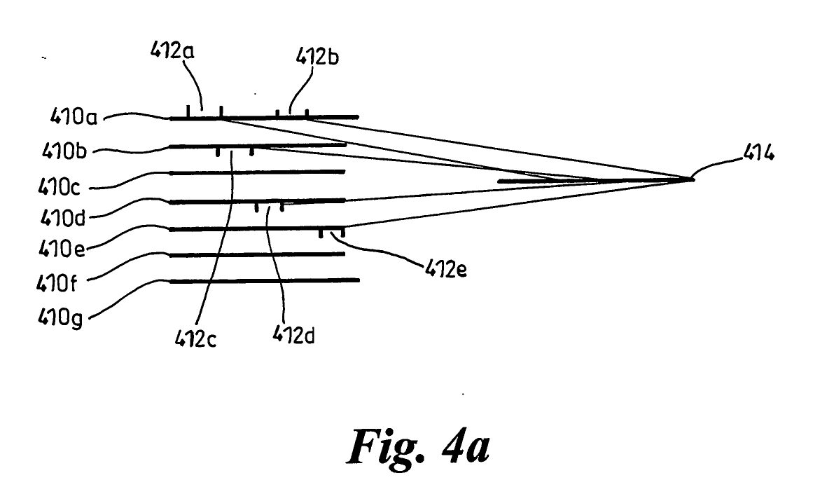

FIG. 4 is a schematic representation of a stack of images captured by the imaging arrangement of FIG. 1;

FIG. 4a is a schematic representation of the formation of a composite initial image from a stack of images;

FIG. 5 is a representation of an image of the device of FIG. 2 showing sub-image borders;

FIG. 5a is a representation of a sample being focussed using a fringe projection method;

FIG. 5b is a plot showing the effects of good and poor focussing on the magnitude of the Fourier component corresponding to the spatial frequency of the fringes shown in FIG. 5a;

FIG. 6 is a vector displacement map of the device of FIG. 3 generated using the arrangement of FIG. 1;

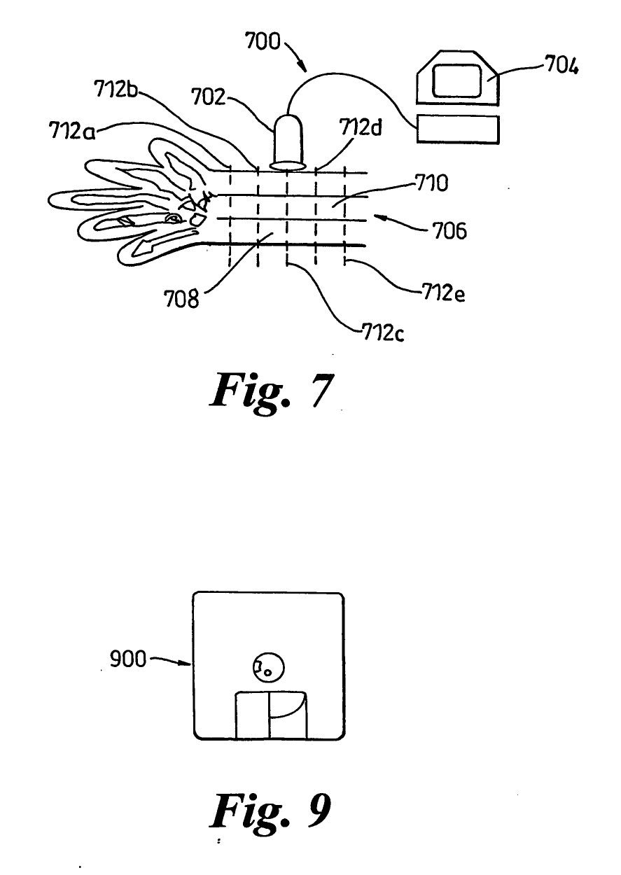

FIG. 7 is an ultrasound transducer, in use imaging hard tissue embedded in soft tissue in accordance with at least one aspect of the present invention;

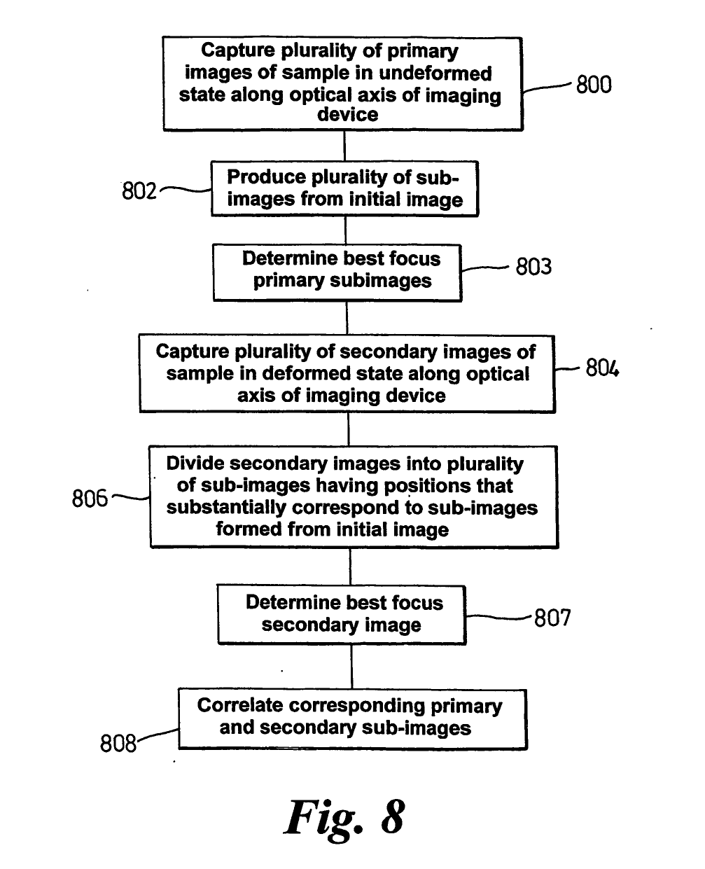

FIG. 8 is a flow chart detailing a method of deformation measurement; and

FIG. 9 is a computer readable medium according to an aspect of the present invention.

Referring now to FIG. 1 a microscope imaging arrangement 100 comprises a microscope body 102 that houses an objective lens 104, a CCD array camera 106, a drive mechanism 108 and a sample stage 110.

The camera 106 is connected to a PC 112, which comprises a processor unit 114, a VDU 116, a keyboard 118 and a mouse 120. The processor unit 114 receives images from the camera 106 and controls the drive mechanism 108 such that the drive mechanism 108 effects relative motion between the lens 104 and the stage 110. The stage 110 is shown with an electronic device package 122 mounted thereupon. The device 122 has structures 124a-c projecting from a surface adjacent the lens 104.

In one embodiment of the present invention a plurality of primary images, usually micrographs, of part of the package 122 are captured using the lens 104 and camera 106 at a number of differing focal planes. The best focus primary image is selected using techniques described hereinafter. The lens 104 typically has a magnification of ×5 to ×50 and a numerical aperture of between 0.1 and 0.5, usually 0.25. The camera 106 typically includes an (640×480) or (1024×1024) active pixel array, usually measuring 6 mm×8 mm.

The initial image is transmitted to the processor unit 114 and can be displayed upon the VDU 116 should a user wish to view it. The processor unit 114 divides the initial image into sub-images. These sub-images are usually 24×24 pixels, or 32×32 pixels, in size.

The package 122 is deformed typically by thermal cycling or mechanical stressing. The deformation can be achieved by in-situ heating or stressing on the stage 110 or by ex-situ heating or stressing.

FIG. 2 shows the package 122 in its undeformed state. The package 122 comprises a substrate 202 having contact pins 204a-d projecting therefrom. In the case of flip chip technologies the contact pins 204a-d will be replaced by solder balls attached to metallisation on a lower surface of the substrate 202. The substrate 202 has active devices 206, 208, 210 mounted thereupon such as, for example random access memory (RAM), a central processor unit (CPU), a frequency synthesiser or an arithmetic logic unit (ALU) or any other suitable device. FIG. 2a is a plan view of the package 122 prior to deformation.

FIG. 3 shows the package 122 following deformation, such as heating, mechanical stressing or a combination of both. The substrate 202 has buckled, resulting in both lateral and vertical displacements of the devices 206-210. An inaccurate measurement of the lateral displacements of the devices 206-210 can be achieved by use of the known techniques described hereinbefore subject to their limitations for example due to focussing errors. However, the measurement of vertical displacements is not readily achievable using the prior art methods, and moreover vertical displacements introduce decorrelation when comparing in-plane measurements of sub-image features. Referring to FIG. 3a, the lateral displacement of the devices 206-210 can be seen relative to their locations in FIG. 2a. As can be seen the true ‘total’ deformation of the package 122 is larger than that suggested by just the in-plane deformation as this neglects the out-of-plane deformation of the package 122.

Referring now to FIG. 1, once a best focus focal plane for imaging part of the undeformed package 122 has been established, and the package 122 is deformed, the drive mechanism 108 moves the microscope body 102 and the CCD camera 106 such that the focal plane of the objective 104 lies below the focal plane established for the undeformed package 122. It will be appreciated that it may be the stage 110 that is moved and not the microscope body 102.

An image is captured by the camera 106 at the new objective—package distance. The drive mechanism 108 then moves the microscope body 102 and camera 106 to a new position closer to the undeformed package's focal plane. Another image is captured at the new position by the camera 106. This sequence of movement of the focal plane of the microscope arrangement 100 and image capture continues through the focal plane established for the undeformed package and away from the upper surface of the package.

The movement of the microscope body 102 will usually be incremented step wise with a pitch Δ, where Δ is typically

$$\frac{1}{( 20 \times {NA}^{2} )} ,$$

such that a stack of 2p+1 ‘through focus’ images are captured, where p determined by an expected amount of out-of-plane deformation. The number of steps, 2p+1, depends upon the sample profile but is typically between 21 and 61. This is shown in FIG. 4 in which an image 400 constitutes the image captured at the focal plane established for the part of undeformed package imaged in the primary image. Secondary images 404a-c are the images captured above the image 400. Each of the secondary images 400, 402a-c, 404a-c are separated from their adjacent image by a step size Δ. Thus, in this instance a total depth of 6 Δ is scanned through the image 400 and centred thereupon.

It will be appreciated that although the stack of images is shown centred upon the image 400 taken at the focal plane established for the undeformed package this need not be the case. An asymmetric distribution of images captured about the image 400 may be appropriate in the case of an expected asymmetric deformation of the package 122. In order to obtain stepwise relative motion between the stage 110 and the microscope body 102 the drive mechanism 108 will usually take the form of a stepper motor or a servomotor.

The processing unit 114 divides each of the images 400-404c into a plurality sub-images. If the image of the undeformed package is divided into an (m×n) array so are the images 400-404c, this is shown in FIG. 5 by the dashed lines. In this instance the image 500 is divided into a (5×4) matrix of sub-images 502a-t. As can be seen from FIG. 5 the two uppermost 502a,e,i,m,q-502b,f,j,n,r and the two most extreme left columns of sub-images 502a,b,c,d-502e,f,g,h overlap, in this case by approximately 25%. The overlap of images reduces the complexity and computational load of subsequent image processing steps by allowing averaging within the overlapping region. A practical upper limit upon the degree of overlapping is 50% of adjoining cells. It will be appreciated that adjacent sub-images may not overlap or may only overlap by a small amount.

Referring now to FIG. 4a a plurality of initial images 410a-g of the undeformed package 122 are captured at varying focal planes as hereinbefore described in relation to the deformed package 122. The initial images 410a-g are divided into respective pluralities of sub-images and the best focus sub-image 412a-e for each region of the package 122 is selected using either the fringe projection method or the spectrum suppression method as detailed hereinafter. Thus, a composite “best focus” initial image 414 is produced. This “best focus” initial image 414 is then compared the secondary sub-images 502a-t as detailed hereinafter and out-of-plane deformation are determined with reference to individual focal planes of the initial sub-images.

The sub-images of each of the (m×n) columns are compared to sub-images of the primary image of part of the undeformed package 122 in order to determine the sub-image that provides the best post deformation focus for that area of the package 122 using techniques that are described hereinafter. Thus, a composite “best-focus” image can be constructed from the best focus sub-images. This composite “best-focus” image can, and usually will, contain sub-images obtained at different focal planes, i.e. at different heights relative to each other. This arrangement reduces errors in the determination of in-plane deformation over current systems due to an increase in the sharpness of focus of the present invention reduces these errors.

Additionally, by ascertaining which of the stack of sub-images constitutes the best-focus image it is possible to determine the amount of out-of-plane deformation occurring at an area of the package 122, i.e. if it is the n^{th} sub-image that is the best focus sub-image the vertical displacement is ±n Δ.

A brief description of three techniques for determining the best focal position of a sub-image that can be readily incorporated into a conventional bright field microscope follows hereinafter.

1. Fringe projection method: with this method an intensity grating is inserted in a field stop plane of the microscope 102. This causes a set of optical fringes to be projected onto the sample surface along the optical axis of the microscope. Defocusing of the sub-image will cause fringe contrast to decrease. This can be measured by taking the Fourier transform of the sub-image, and monitoring the amplitude of the Fourier component corresponding to the fringe frequency. The sub-image with the largest Fourier component corresponding to the fringe frequency is the best focus sub-image. FIG. 5a shows the sample 122 having fringes 504a-e of a known spatial frequency projected upon it. FIG. 5b shows the effect of poor focus (plot A) and good focus (plot B) upon the magnitude of the Fourier component corresponding to the fringes spatial frequency.

2. Spectrum suppression method: with this method, a Fourier transform is taken of each sub-image. It is well known that one effect of defocusing the sample is the attenuation of a sample frequency spectrum. In practice the attenuation in the mid-spatial frequency range provides the best measure typically between 0.25 and 0.5 of the optical transfer cut-off frequency defined by the lens NA. By monitoring the amplitudes of the frequency components near this range, the best focus position of the sub-image can be determined by selecting the sub-image with the largest mid-spatial frequency amplitudes, for example the contacts 204a-d. The effect of poor focussing compared to good focussing upon the magnitude of the Fourier component corresponding to the selected frequency is the similar to that shown in FIG. 5b.

3. Correlation method: with this method a two dimensional correlation is taken between each deformed sub-image and the corresponding undeformed, sub-image. Defocused sub-images will result in correlation functions with reduced peak value. Thus the correlation function with the highest peak will correspond to the in focus sub-image, i.e. match each (possibly the best focussed) initial sub-image with the best correlated of the equivalent secondary sub-images. This method gives optimal results in determining the position of displaced objects (e.g. component identification and positioning in manufacturing) but may give ambiguous results on deformed objects. 1D-correlation is also possible and has been applied to ultrasound.

Of the methods, the first one is potentially most accurate. It is also suitable for surfaces with sparse features. The advantage of the other two methods is that no additional optical component is required.

Techniques such as curve fitting can be applied to all three methods, to improve the sensitivity of the measurements.

Referring now to FIG. 6, a strain map 600 of the deformed device 122 is composed of best focus sub-images. Each of the best focus sub-images may not and indeed probably will not correspond to the same distance away from the focal plane established for the undeformed device 122. By utilising the best focus sub-images the strains at various points on the surface can be accurately calculated, typically with an accuracy of 0.1 to 0.01 pixels. In FIG. 6 the calculated strains are represented as vector arrows 604 although they could alternatively be represented as numerical values, a greyscale or a colour scale, or any other suitable way of differentiating between regions of differing strain.

Referring now to FIG. 7, an ultrasound imaging arrangement 700 comprises an ultrasound transducer 702 that is in communication with a PC 704, or other suitable processing device.

The transducer 702 is placed against a patient, shown as an arm 706 in this instance and soft tissue 708, such as muscle or fat, surrounding hard tissue 710, for example bone is palpitated. Ultrasound images are acquired along the arm 706 during the palpitation, so as to form a stack of images 712a-e. The soft tissue 708 under palpitation appears as a mass having uniform strain therein and the hard tissue 710 appears as a region having non-uniform strain. The stack of ultrasound images are processed in a similar manner as hereinbefore described in relation to optical images. Due to the difference in the distribution of the strains within the soft tissue 708 and the hard tissue 710 the strains within the hard tissue 710 can be measured and imaged, as can the extent of the hard tissue 710.

It will be appreciated that although shown as a bone the hard tissue may be any tissue that is significantly more solid than the surrounding tissues, for example tumour tissue surrounded in fat or muscle such as a breast tumour.

When images of an area of interest of a patient are recorded using the imaging arrangement 700 are temporally separated it is possible to determine the rate of change of size of the hard tissue 710 by a comparison of the images and/or strain maps generated. For example this technique allows the rate of growth/reduction of a tumour, the rate of knitting of a broken bone or the rate of migration of biological materials, e.g. cells, into a bio-compatible supporting matrix to be determined.

Referring now to FIG. 8 this is a flowchart of a method of deformation analysis according to the present invention in which a plurality of primary images of a sample in an undeformed state are captured at a plurality of focal planes, using an imaging device, typically along an optical axis of the device (step 800).

Subsequently a plurality of primary sub-images are produced from these primary images by a processor (step 802). A best focus primary sub-image is determined for each area within the primary image (Step 803).

A plurality of secondary images of the sample in its deformed state are captured by the imaging device, typically, at various points along the imaging devices optical axis (Step 804). Each secondary image is divided into a plurality of sub-images each having a position that substantially corresponds to the sub-images formed from the initial image (step 806). The best focus secondary sub-image for each initial sub-image is determined (step 807). The best focus primary sub-images are correlated with each corresponding best focus secondary sub-images using a processor (step 808).

Referring now to FIG. 9, this shows a computer readable medium 900, for example a magnetic disc, an optical disc, a CD-rom, or a DVD, having software encoded thereupon suitable for causing an apparatus to execute the method outlined in relation to FIG. 8.

1-17. (canceled)

18. An image analysis method comprising the steps of:
i) capturing at least two primary images of at least one part of a sample in a first state using imaging means, the at least two primary images being captured at different focal planes;
ii) capturing at least two secondary images of said at least one part of said sample in a second state using imaging means, the at least two secondary images being captured at differing focal planes;
iii) selecting one of said primary images that has the best definition of at least one feature therein using processing means;
iv) selecting one of said secondary images which has the best definition of said at least one feature therein using processing means; and
v) comparing the primary and secondary images selected in steps (iii); and (iv) in order to determine the displacement, if any, of a feature within said part of said sample.

19. The method of claim 18 further comprising the step of providing the imaging means in a form including a form from the group consisting of a microscope and an ultrasound transducer.

20. The method of claim 18, further comprising the step of determining a best focus sub-image from the plurality of second plurality of images in step (iv).

21. The method of claim 18, further comprising the step of measuring an out-of-plane displacement of at least one feature by multiplying a number of steps moved by the imaging means in achieving a desired secondary image quality by the step size.

22. The method of claim 18, further comprising the step of providing said primary images by using an initial image captured by the imaging means having a single nominal focal plane depth.

23. The method of claim 18, further comprising the step of using a composite image composed of sub-images each defining a focal plane depth to provide said primary images.

24. The method of claim 18, further comprising the step of outputting to an output device at least one from the group consisting of a strain map, a deformation map, and a numerical measure of deformation.

25. The method of claim 18, further comprising the step of measuring a deformation of the sample in the (xy) plane to a sub-pixel resolution of at least 0.1 pixels.

26. An image analysis apparatus comprising imaging means arranged to capture an image of at least part of a sample, processing means arranged to process the image and drive means arranged to effect relative motion between the sample and the imaging means wherein the imaging means is arranged to capture at least two images of a part of the sample at at least two focal planes, relative movement between the sample and the imaging means being effected by the drive means the processing means being arranged to determine a correlation of each of said images with a reference and to select one of the at least two images upon the basis of said correlation, and the said processing means being further arranged to determine a displacement, if any, of at least one feature within said part of the sample.

27. An image analysis apparatus according to claim 26 further comprising having the imaging means include means from the group consisting of a microscope; and an ultrasound transducer.

28. An image analysis apparatus according to claim 26 wherein the processing means is arranged to select a best focus sub-image from the at least two images.

29. An image analysis apparatus according to claim 26, arranged to have the reference be provided using a primary image from an image having a nominal single focal plane.

30. An image analysis apparatus according to claim 26, arranged to have the reference be provided using a sub-image from a composite primary image where each sub-image defines a localised focal plane.

31. A data structure encoded upon a computer readable medium the data structure including:
a first entry corresponding to a data set indicative of part of a sample in a first state;
a plurality of secondary entries corresponding to at least two inputs received from an imaging means, indicative of said part of the sample in a second state;
the first entry and the at least two second entries arranged to be operated upon by processing means to enable respective subsets of data to be derived and to be operated upon by the processing means to determine a match therebetween.

32. A data structure according to claim 31 wherein said first entry and said plurality of secondary entries are image data files.

33. A data structure according to claim 31 wherein said subsets of data being sub-image data files relating to portions of an area imaged by said imaging means.

34. A data structure according to claim 31, wherein said subsets of data files are arranged to be operated upon by the processing means by the execution of a technique from the group consisting of a correlation technique, a fringe projection technique, and a spectrum suppression technique.

35. A data structure according to claim 31 wherein said second entries correspond to at least two image data sets obtained at differing focal planes.

36. Computer software which when run on an apparatus causes a processing means of the apparatus to generate a data set indicative of an initial image of a sample in a first state and further causes said processing means to produce a plurality of data sub-sets indicative of regions of the sample from said data set, the software:
causing imaging means to capture a plurality of secondary images of the sample in a second state at at least two of focal planes and causing said processing means to produce a plurality of sub-images corresponding substantially in location to the regions of the sample defined by said data sub-sets from each of said plurality of secondary images and subsequently causing said processing means to correlate at least one of said data sub-sets with each corresponding one of said plurality of secondary sub-images by using said processing means to select one of the said secondary sub-images for each said data sub-set based upon said correlation and determining a displacement, if any, of least one feature within said sub-image.

37. An image analysis method comprising the steps of:
i) capturing at least two primary images of at least one part of a sample in a first state using imaging means, the at least two primary images being captured at different focal planes;
ii) capturing at least two secondary images of said at least one part of said sample in a second state using imaging means, the at least two secondary images being captured at differing focal planes;
iii) selecting one of said primary images that has the best definition of at least one feature therein using processing means;
iv) selecting one of said secondary images which has the best definition of said at least one feature therein using processing means; and
v) comparing the primary and secondary images selected in steps (iii); and (iv) in order to determine the displacement, if any, of a feature within said part of said sample; and
providing the imaging means in a form including a form from the group: (i) including a microscope; (ii) including an ultrasound transducer; and
determining a best focus sub-image from the plurality of second plurality of images in step (iv);
measuring an out-of-plane displacement of at least one feature by multiplying a number of steps moved by the imaging means in achieving a desired secondary image quality by the step size;
further comprising the steps of measuring a deformation of the sample in the (xy) plane to a sub-pixel resolution of at least 0.1 pixels, and
outputting at least one of the following to an output device: a strain map, a deformation map, a numerical measure of deformation.
